(19) United States
(12) Patent Application Publication
(10) Pub. No.: US 2009/0040866 A1
(43) Pub. Date: Feb. 12, 2009

(54) ORBITAL AND RECIPROCAL WATER BATH

(76) Inventors: William A. Rollin, III, Hatboro, PA (US); Brad P. Thorstensen, Haddon Township, NJ (US)

Correspondence Address: FOX ROTHSCHILD LLP, 1101 MARKET STREET, SUITE 2600, PHILADELPHIA, PA, 19107-2950, US

(21) Appl. No.: 11/836,271

(22) Filed: Aug. 9, 2007

(51) Int. Cl. B01F 11/00

(52) U.S. Cl. 366/219

(57) ABSTRACT

A water bath for laboratory use capable of two mixing motions is disclosed. Master magnets are mounted on eccentric shafts turned in a circular orbit by an electric motor beneath the bath. Slave magnets are mounted on a basket within the bath. The basket rides on spherical bearings within the bath. The bearings are received within tracks on the basket. A first set of the tracks are linear. A second set of the tracks are endless. When the bearings are received in the linear tracks, the basket moves in linear reciprocal motion in response to motion of the master magnets. When the bearings are received in the endless tracks, the basket moves in an orbit in response to motion of the master magnets. The tracks and the bearings are positioned so that a particular motion may be selected by orienting the basket within the bath.

### FIELD OF THE INVENTION

The invention concerns water baths capable of dual mixing modes for laboratory use.

### BACKGROUND OF THE INVENTION

Various laboratory procedures, such as Northern and Southern hybridizations, the de-staining of gels, the incubation of cells or bacteria cultures and wash processes require mixing of constituents while maintaining the constituents at a constant temperature. For many applications, this is conveniently accomplished through the use of a water bath device wherein a basket which holds containers filled with the constituents, such as test tubes or flasks, is positioned within a tub containing water held at a constant temperature by heating elements. The basket is moved within the bath to agitate the contents of the containers as required according to the procedure. The speed of the motion as well as its duration, and the temperature of the water within the bath are all controlled by the device.

It is advantageous to be able to vary the type of motion which the basket executes within the bath, as some procedures require a gentle agitation afforded by orbital motion of the basket. In contrast, other procedures require vigorous mixing normally associated with reciprocal basket motion. Prior art water bath devices capable of both orbital and reciprocal motion have complicated mechanisms which require various adjustments be made to the components to switch between the two types of motion. There is clearly a need for a water bath device which can be easily and conveniently switched between the orbital and reciprocal modes of motion without extensive adjustments or modifications to the mechanisms of the device.

### SUMMARY OF THE INVENTION

The invention concerns a device for agitating a miscible material in a container. The device comprises a plurality of spherical bearings positioned in spaced relation to one another. A supporting structure for holding the container, is positionable overlying the spherical bearings and is supportable thereon. A plurality of tracks are mounted on the supporting structure and are positioned in spaced relation to one another. Each of the tracks receives one bearing of the plurality of spherical bearings. The supporting structure is movable along a path defined by the tracks when the spherical bearings are received within the tracks.

In one embodiment, a first group of tracks defines a first path of movement for the supporting structure, and a second group of tracks defines a second path of movement for the supporting structure.

In a particular embodiment, the bath device comprises four of the spherical bearings and four of the tracks. The first group of tracks are linear tracks arranged parallel to one another and define a linear path. A first two of the spherical bearings are positioned separated from one another by a first distance. A second two of the spherical bearings are positioned in spaced relation to the first two spherical bearings. The second two spherical bearings are separated from one another by a second distance greater than the first distance. A first two of the linear tracks are separated from one another by the first distance for receiving the first two of the spherical bearings. A second two of the linear tracks are positioned in spaced relation to the first two linear tracks. The second two linear tracks are separated from one another by the second distance for receiving the second two spherical bearings. The supporting structure is movable along the linear path when the spherical bearings are received within the linear tracks.

Each of the linear tracks may comprise a plate having a linear groove therein. The groove has an arcuate cross section with a radius of curvature substantially equal to the radius of curvature of the spherical bearings.

The second tracks are comprised of a first two endless tracks mounted on the supporting structure and separated from one another by the first distance for receiving the first spherical bearings. A second two endless tracks are mounted on the supporting structure in spaced relation to the first two endless tracks. The second two endless tracks are separated from one another by the second distance for receiving the second spherical bearings. The first two linear tracks are positioned between the second two endless tracks, and the first two endless tracks are positioned between the second two linear tracks. The supporting structure is movable along the linear path when the spherical bearings are received within the linear tracks, and is movable along an endless path defined by the endless tracks when the spherical bearings are received within the endless tracks.

Each of the endless tracks may comprise a plate having a circular groove therein. The groove has an arcuate cross section with a radius of curvature substantially equal to the radius of curvature of the spherical bearings.

The device according to the invention may further comprise an electric motor positioned beneath the supporting structure. An eccentric shaft is coupled with the motor. The motor rotates the shaft. A master magnet is mounted on the eccentric shaft. The master magnet moves in a circular path when the shaft is rotated by the motor. A slave magnet is mounted on the supporting structure and is in spaced relation to the master magnet. The slave magnet is magnetically coupled to the master magnet. The supporting structure moves along the endless path when the spherical bearings are received within the endless tracks and the motor rotates the master magnet. The supporting structure moves along the linear path when the spherical bearings are received within the linear tracks and the motor rotates the master magnet.

The device also comprises a tub having a plurality of sidewalls attached to a bottom. The bottom is positioned between the master and the slave magnets. The spherical bearings are mounted on the bottom within the tub.

### BRIEF DESCRIPTION OF THE DRAWINGS

FIG. 1 is a perspective view of an orbital and reciprocal water bath device according to the invention;

FIG. 2 is a cross-sectional view taken at line 2-2 of FIG. 1;

FIG. 3 is a sectional-view taken at line 3-3 of FIG. 2;

FIG. 4 is an exploded perspective partial view showing the device in a linear motion configuration;

FIG. 5 is an exploded perspective partial view showing the device in an orbital motion configuration; and

FIG. 6 is an exploded perspective partial view of another embodiment of the invention.

### DETAILED DESCRIPTION OF THE EMBODIMENTS

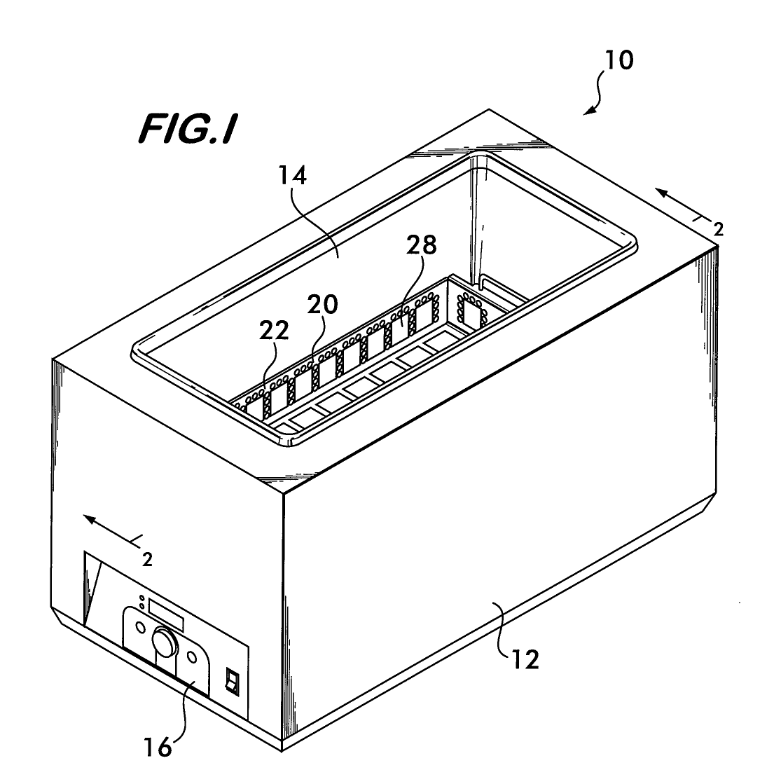

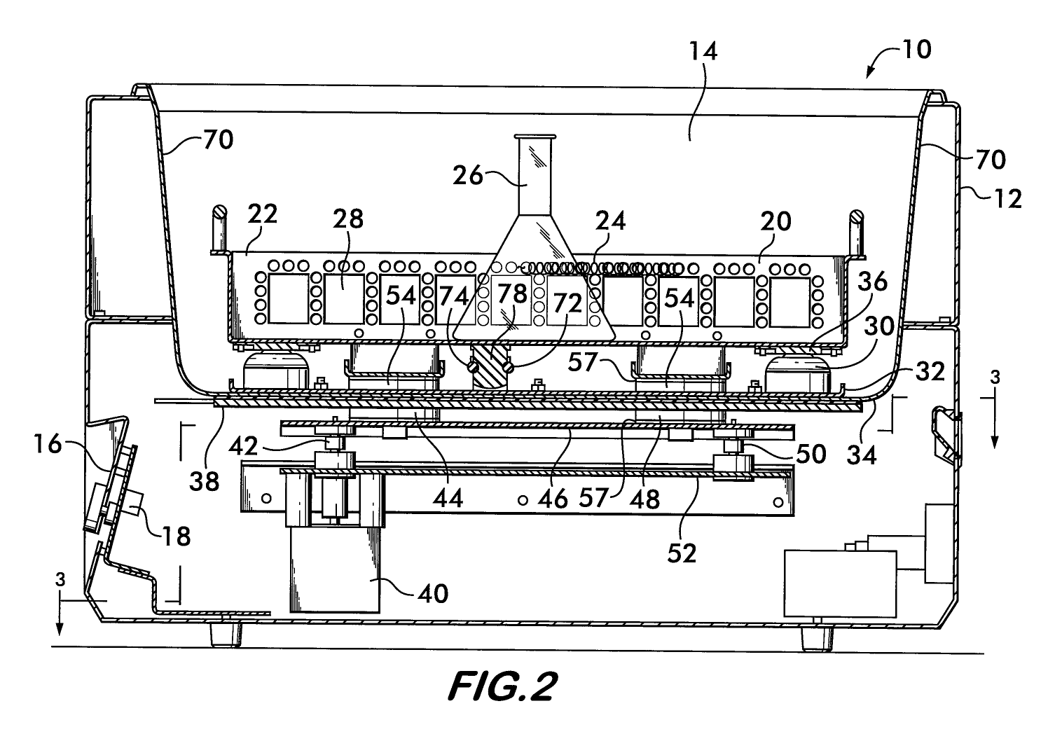

FIG. 1 is a view of an orbital and reciprocal water bath device 10 according to the invention. Bath device 10 comprises a housing 12 which contains a tub 14 for holding water or other liquid to be used in the bath. A control panel 16 is conveniently mounted on the housing for controlling the operation of the bath device, for example, activation of the bath device, setting the bath temperature and the frequency and duration of the agitation of the bath contents. As best shown in FIG. 2, the control panel 16 interfaces with a control system 18, preferably in the form of a microprocessor and associated electronic circuitry, which controls the various components of the bath device as described below.

As further shown in FIG. 2, a container supporting structure 20 is positionable within the tub 14. In this example, the container supporting structure 20 takes the form of a basket 22 having spring elements 24 for holding a flask 26 or other containers to be immersed within the bath. The basket is perforated with various openings 28 to promote flow of bath water through the basket and over the containers held therein. Basket 22 is supported on a plurality of spherical bearings 30 which are mounted on a bearing plate 32 attached to the bottom 34 of the tub 14. A plurality of plates 36 are mounted on the bottom of the basket 22. The plates 36 have tracks (described below) which receive the spherical bearings 30 which support the basket. The basket rides on the bearings, its motion guided by the tracks in plates 36, and is readily removable for adding and removing containers as well as changing the mode of motion of basket 22 within the bath as described below.

The tub 14 is heated by electrical resistive heaters 38 mounted on the underside of the tub. Heaters 38 are controlled by the control system 18 to maintain the bath at a constant temperature. Temperature measurement of the bath is effected preferably by means of a thermistor (not shown) which returns electronic signals indicative of the bath temperature to the control system to afford feedback for positive temperature control. The control system maintains temperature stability and uniformity within +/−0.1° C. over a temperature range between 5° C. above ambient to 99° C.

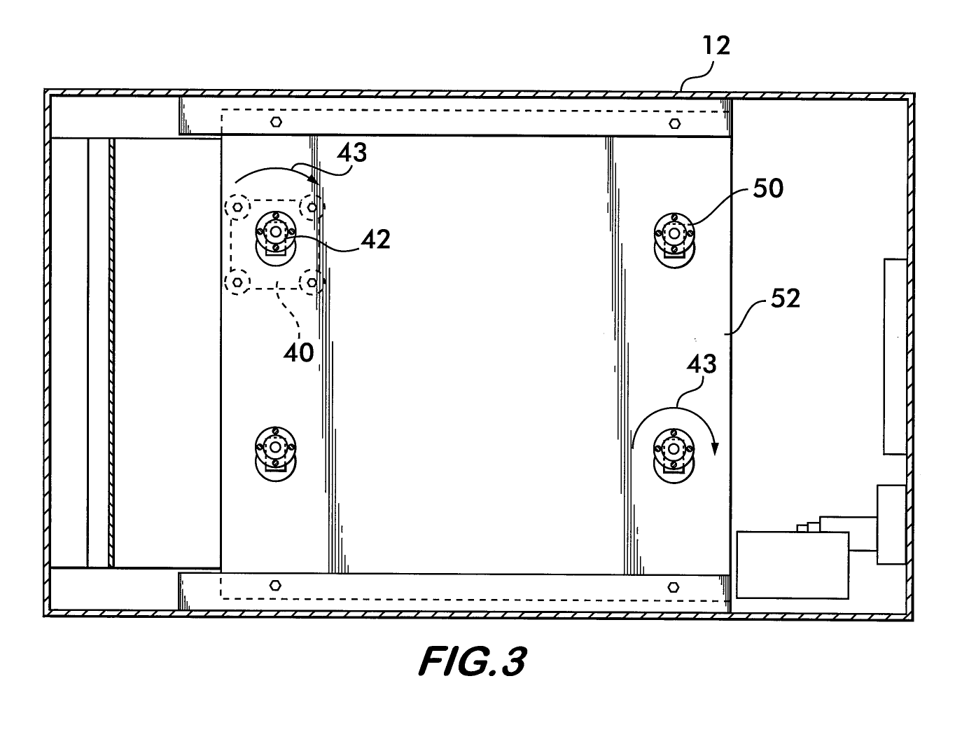

Motion of the basket 22 is effected by an electric motor 40 mounted beneath the tub 14. Motor 40 is controlled by the control system 18 and rotates an eccentric shaft 42. A master magnet 44 is attached to the eccentric shaft by means of an intervening plate 46. Use of the intervening plate 46 allows additional master magnets 48 to be positioned beneath the tub as well. The additional master magnets 48 are each secured to the intervening plate 46. The motor 40 is attached to a fixed plate 52 mounted to the housing 12. Additional eccentric shafts 50, also mounted on the fixed plate 52, support the intervening plate 46 (see FIGS. 2 and 3). Motor 40 rotates the eccentric shaft 42, which moves in an orbital motion 43 and causes the intervening plate 46 to which it is attached to move in an orbital motion due to the eccentricity of shafts 42 and 50. The various master magnets 44 and 48, being fixed to the intervening plate, also execute orbital motion.

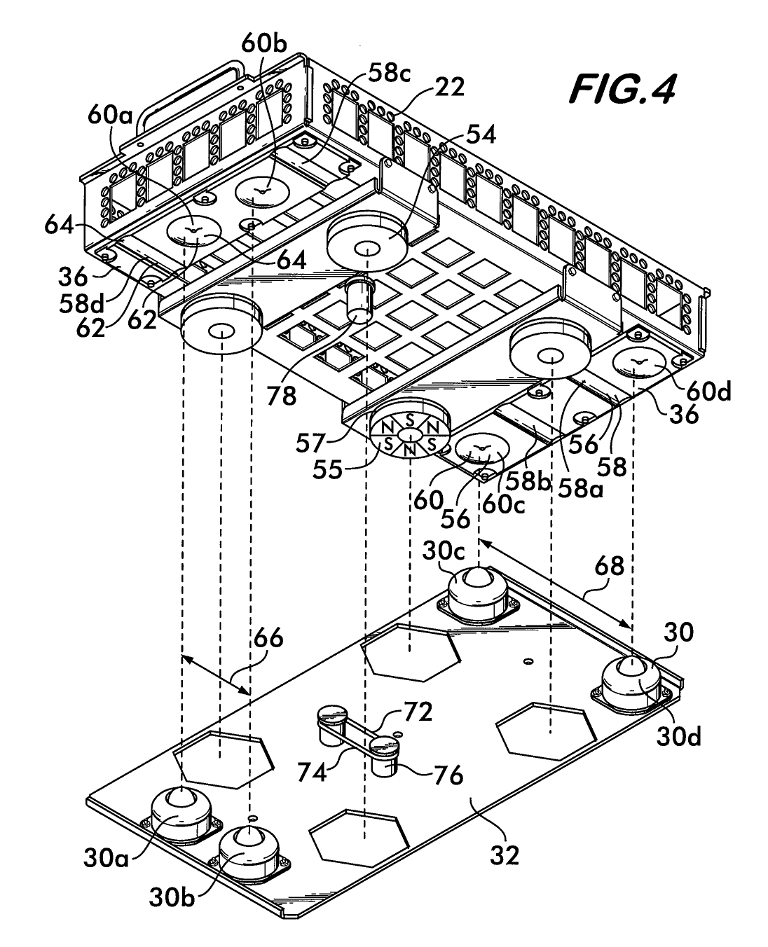

As shown in FIG. 2, the master magnets 44 and 48 are magnetically coupled through the bottom 34 of tub 14 with corresponding slave magnets 54 mounted on the bottom of basket 22. It is, therefore, advantageous to make the tub from non-magnetic material. Non-magnetic stainless steel alloys are preferred for durability and corrosion resistance. Preferably, there are four master and slave magnet sets within the device 10 to ensure that coupling between the magnets is maintained and the basket performs the required motion at the desired frequency without significant lag or loss of coupling due to inertial effects. To additionally enhance magnetic coupling, the master and slave magnets 44, 48 and 54 are preferably multi-pole magnets having a plurality of N-S poles 55 spaced angularly around the magnet as shown in FIG. 4. Six N-S poles are preferred. A washer 57 formed of a magnetic material is mounted behind each magnet and used to direct the magnetic fields of the magnets toward one another.

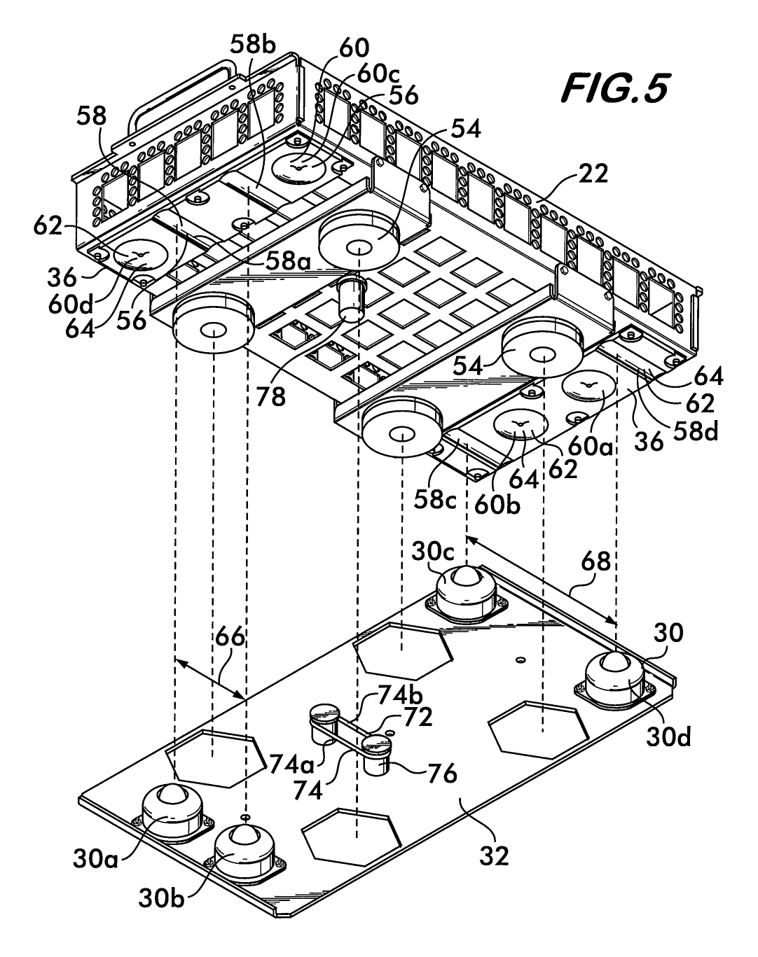

FIGS. 4 and 5 show detailed views of the track plates 36 which are mounted on the bottom of the basket 22. The path which the basket takes in its motion is determined by the shape of the tracks 56 in the plates 36. Two forms of tracks are advantageous, linear tracks 58, and endless tracks 60. The tracks may comprise grooves 62 which have an arcuate cross-section 64 having a radius of curvature substantially equal to the radius of curvature of the spherical bearings 30. Matching of the radii between the grooves and the bearings prevents excessive motion of the basket on the bearings.

To permit the basket to execute either linear reciprocal motion or orbital motion in response to the motion of master magnets 44 and 48, both linear tracks 58 and endless tracks 60 are positioned on the basket. As shown in FIG. 4, four spherical bearings 30 are used in the example device. A first two of the spherical bearings, 30a and 30b, are positioned in spaced apart relation to one another at a first distance 66. A second two of the spherical bearings 30c and 30d, are positioned spaced from the first two bearings, and spaced apart from one another at a second distance 68 greater than the first distance. The endless tracks 60 mounted on the underside of basket 22 are arranged on the basket so that a first two of the tracks, 60a and 60b, are spaced from one another at the first distance 66. A second two of the endless tracks, 60c and 60d are spaced from one another at the second distance 68. This track spacing conforms with the bearing spacing and permits the basket 22 to be placed on the spherical bearings 30 with the bearings riding within the endless tracks 60. The tracks cooperate with the bearings to permit orbital motion of the basket in response to the orbital motion of the master magnets. Thus, when the motor 40 rotates the master magnets 44 and 48 the magnetically coupled slave magnets 54 force the basket 22 to move, and the tracks 60a-60d constrain the motion of the basket to orbital motion along a path defined by the endless tracks 60. In this example, the endless tracks are circular, resulting in circular orbital motion, but other shapes, such as ellipsoidal or oval, are also feasible.

As shown in FIG. 5, the linear tracks 58, also mounted on the underside of basket 22, are arranged on the basket so that a first two of the tracks, 58a and 58b, are spaced from one another at the first distance 66. A second two of the linear tracks, 58c and 58d are spaced from one another at the second distance 68. This track spacing also conforms with the bearing spacing and permits the basket 22 to be placed on the spherical bearings 30 with the bearings riding within the linear tracks 58. The tracks cooperate with the bearings to permit linear reciprocal motion of the basket along a path defined by the tracks in response to the orbital motion of the master magnets. Thus, when the motor 40 rotates the master magnets 44 and 48, the magnetically coupled slave magnets 54 force the basket to move, and the linear tracks 58 constrain the motion of the basket to a linear, reciprocal motion defined by the linear shape of the tracks 58.

It is noted in FIGS. 4 and 5 that the positions of the first and second linear tracks 58a-b and 58c-d respectively, are reversed on the basket 22 from the first and second endless tracks, 60a-b and 60c-d respectively. As shown in Figures, the more closely spaced linear tracks 58a and 58b are positioned between the more widely spaced endless tracks 60c and 60d, whereas the more closely spaced endless tracks 60a and 60b, are positioned between the more widely spaced linear tracks 58c and 58d. This configuration of the track spacing permits the motion of the basket 22 to be determined depending upon which way it is positioned within the tub 14. For linear motion, the basket is oriented relatively to the bearing plate 32 as shown in FIG. 5, with the linear tracks 58 aligning with the bearings 30. For orbital motion, the orientation of the basket relative to the bearing plate is merely reversed, as shown in FIG. 4, so that the endless tracks 60 align with the bearings 30.

For a practical device 10, the orbital radius of the basket is about 10 mm and the frequency of the basket motion may be continuously adjusted between about 20 and about 200 cycles per minute.

When the basket 22 is supported on spherical bearings 30 received within the linear tracks 58 as shown in FIG. 5, it is observed that the basket may bump the opposing sidewalls 70 of the tub 14 (see FIG. 2) for certain linear motion frequencies. This action is avoided by positioning a pair of stop surfaces 72 beneath the basket. As shown in FIGS. 2 and 5, the stop surfaces may comprise an elastic loop 74 stretched between two posts 76 attached in spaced relation on the bearing plate 32. The stretched elastic loop 74 presents oppositely disposed segments 74a and 74b which are oriented transversely to the motion of the basket 22. A pin 78 projects from the bottom of basket 22 toward the bearing plate 32. The pin 78 is located on the basket 22 and the loop 74 is located on the bearing plate 32 such that the pin is positioned between the segments 74a and 74b only when the spherical bearings 30 are received within the linear tracks 58 (FIG. 5). When the bearings are received within the endless tracks 60, the pin 78 is spaced away from the elastic segments so that it does not make contact with them, and the motion of the basket is not affected by the presence of the stop surfaces 72.

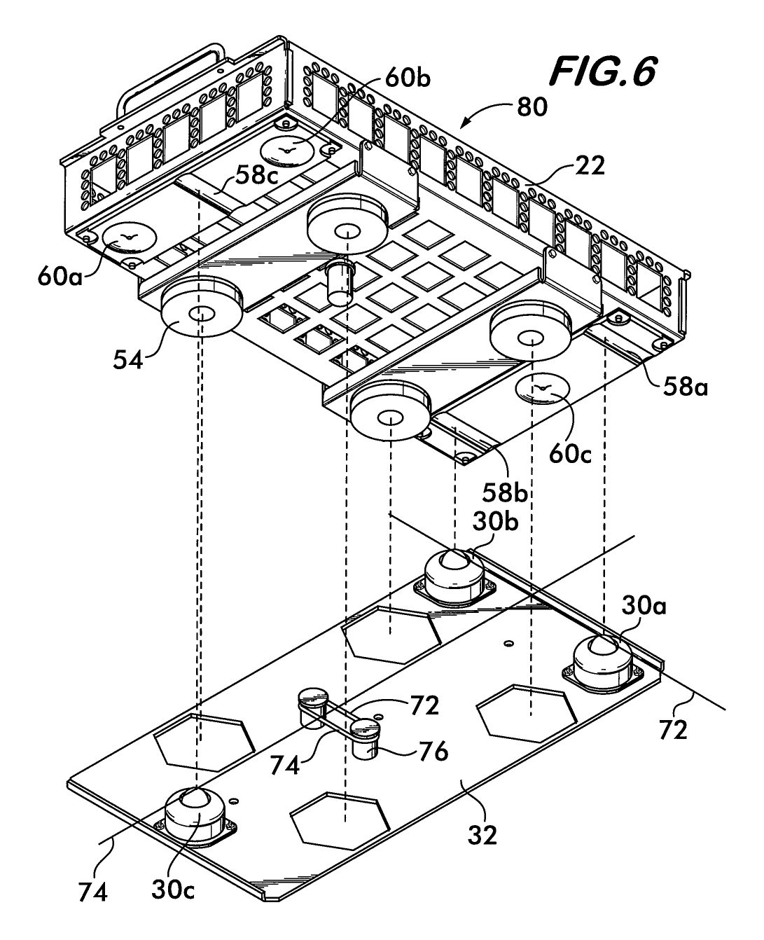

In another embodiment, shown in FIG. 6, the bath device 80 has three spherical bearings 30a, 30b and 30c spaced in a triangular plan form with two of the bearings 30a and 30b in spaced relation along a line 72 and the third bearing 30c positioned spaced from the first two along a line 74 which bisects the first line 72. The basket 22 in this embodiment has three linear tracks 58a, 58b and 58c, and three endless tracks 60a, 60b and 60c. The tracks are arranged so that one orbital track, 60c is positioned between two linear tracks 58a and 58b, and one linear track 58c, is positioned between two orbital tracks 60a and 60b. This triangular configuration of bearings and tracks again makes it possible to select the type of motion of the basket 22 merely by the orientation of basket 22 within the tub 14. If, as shown in FIG. 6, the basket 22 is oriented to present the linear tracks 58a-58c to the bearings 30a-30c, then the basket will execute linear motion when motor 40 rotates the eccentric shaft 42. If the orientation of the basket is reversed, then the orbital tracks 60a-60c will receive the bearings 30a-30c and the basket will execute orbital motion determined by the shape of the tracks.

Orbital and reciprocal bath devices according to the invention provide improved versatility over prior art bath devices in permitting either one of two different mixing modes to be executed based upon the orientation of the container support device within the tub of the bath. The invention eliminates complicated mechanisms that must be adjusted to switch form one mixing mode to the other, thereby simplifying operation and improving reliability.

1. A device for agitating a miscible material in a container, said device comprising:
a plurality of spherical bearings positioned in spaced relation to one another;
a supporting structure for holding said container, said supporting structure being positionable overlying said spherical bearings and being supportable thereon;
a plurality of tracks mounted on said supporting structure and positioned in spaced relation to one another, each said track receiving one bearing of said plurality of spherical bearings; and
wherein said supporting structure is movable along a path defined by said tracks when said spherical bearings are received within said tracks.

2. A device according to claim 1, wherein a first group of said tracks defines a first path of movement for said supporting structure and a second group of tracks defines a second path of movement for said supporting structure.

3. A device according to claim 2, comprising four of said spherical bearings and four of said tracks, wherein:
said tracks are linear tracks arranged parallel to one another and defining a linear path;
a first two of said spherical bearings are
positioned separated from one another by a first distance; a second two of said spherical bearings are
positioned in spaced relation to said first two spherical bearings, said second two spherical bearings are separated from one another by a second distance greater than said first distance;
a first two of said linear tracks are separated from one another by said first distance for receiving said first two of said spherical bearings;
a second two of said linear tracks are positioned in spaced relation to said first two linear tracks, said second two linear tracks being separated from one another by said second distance for receiving said second two spherical bearings; and
wherein said supporting structure is movable along said linear path when said spherical bearings are received within said linear tracks.

4. A device according to claim 3, wherein each of said linear tracks comprises a plate having a linear groove therein.

5. A device according to claim 4, wherein said groove has an arcuate cross section with a radius of curvature substantially equal to the radius of curvature of said spherical bearings.

6. A device according to claim 3, further comprising:
a first two endless tracks mounted on said supporting structure and separated from one another by said first distance for receiving said first spherical bearings;
a second two endless tracks mounted on said supporting structure in spaced relation to said first two endless tracks, said second two endless tracks being separated from one another by said second distance for receiving said second spherical bearings; and
wherein said first two linear tracks are positioned between said second two endless tracks, and said first two endless tracks are positioned between said second two linear tracks, said supporting structure being movable along said linear path when said spherical bearings are received within said linear tracks, said supporting structure being movable along a endless path defined by said endless tracks when said spherical bearings are received within said endless tracks.

7. A device according to claim 6, wherein each of said endless tracks comprises a plate having a circular groove therein.

8. A device according to claim 7, wherein said groove has an arcuate cross section with a radius of curvature substantially equal to the radius of curvature of said spherical bearings.

9. A device according to claim 6, further comprising:
an electric motor positioned beneath said supporting structure;
an eccentric shaft coupled with said motor, said motor rotating said shaft;
a master magnet mounted on said eccentric shaft, said master magnet moving in a circular path when said shaft is rotated by said motor;
a slave magnet mounted on said supporting structure and in spaced relation to said master magnet, said slave magnet being magnetically coupled to said master magnet; and
wherein said supporting structure moves along said endless path when said spherical bearings are received within said endless tracks and said motor rotates said master magnet, and said supporting structure moves along said linear path when said spherical bearings are received within said linear tracks and said motor rotates said master magnet.

10-11. (canceled)

12. A device according to claim 9, further comprising a tub having a plurality of sidewalls attached to a bottom, said bottom being positioned between said master and said slave magnets, said spherical bearings being mounted on said bottom within said tub.

13. A device according to claim 9, further comprising:
first and second stop surfaces positioned in spaced relation beneath said supporting structure; and
a pin projecting from said supporting structure toward said stop surfaces, said pin being positioned between said stop surfaces when said spherical bearings are received within said linear tracks, said pin being engageable with said stop surfaces upon motion of said supporting structure along said linear path, said stop surfaces limiting said linear motion of said supporting structure.

14. (canceled)

15. A device according to claim 2, comprising:
three of said spherical bearings;
three of said tracks, said tracks being endless and defining a endless path;
wherein a first and a second of said spherical bearings are positioned in spaced relation to one another;
a third one of said spherical bearings is positioned in spaced relation to said first two spherical bearings along a first line that perpendicularly bisects a second line between said first and second bearings;
a first and second of said endless tracks are separated from one another for receiving said first and second spherical bearings; and
a third one of said endless tracks is positioned in spaced relation to said first and second endless tracks for receiving said third one of said spherical bearings, said supporting structure being movable along said endless path when said spherical bearings are received within said endless tracks.

16. A device according to claim 15, further comprising:
first and second parallel linear tracks mounted on said supporting structure and positioned in spaced relation from one another and defining a linear path;
a third linear track mounted on said supporting structure in spaced relation to said first and second linear tracks along said first line; and
wherein said third linear track is positioned between said first and second endless tracks, and said third endless track is positioned between said first and second linear tracks, said supporting structure being movable along said endless path when said spherical bearings are received within said endless tracks, said supporting structure being movable along said linear path defined by said linear tracks when said spherical bearings are received within said linear tracks.

17. A device for agitating a miscible material in a container, said device comprising:
a plurality of spherical bearings positioned in spaced relation to one another;
a basket for holding said container, said basket being positionable overlying said spherical bearings and being supportable thereon;
a plurality of circular tracks mounted on said basket and positioned in spaced relation to one another, each said track receiving one bearing of said plurality of spherical bearings; and
wherein said basket is movable along a circular path defined by said circular tracks when said spherical bearings are received within said circular tracks.

18. A device according to claim 17, comprising four of said spherical bearings and four of said circular tracks, wherein:
a first two of said spherical bearings are positioned separated from one another by a first distance;
a second two of said spherical bearings are positioned in spaced relation to said first two spherical bearings, said second two spherical bearings are separated from one another by a second distance greater than said first distance;
a first two of said circular tracks are separated from one another by said first distance for receiving said first two spherical bearings; and
a second two of said circular tracks are positioned in spaced relation to said first two circular tracks, said second two circular tracks being separated from one another by said second distance for receiving said second two spherical bearings.

19. A device according to claim 18, further comprising:
a first two parallel linear tracks mounted on said basket and separated from one another by said first distance for receiving said first two spherical bearings;
a second two linear tracks mounted on said basket in spaced relation to said first two linear tracks, said second two linear tracks being separated from one another by said second distance for receiving said second two spherical bearings; and
wherein said first two circular tracks are positioned between said second two linear tracks, and said first two linear tracks are positioned between said second two circular tracks, said basket being movable along said circular path when said spherical bearings are received within said circular tracks, said basket being movable along a linear path defined by said linear tracks when said spherical bearings are received within said linear tracks.

20. A device according to claim 19, further comprising:
an electric motor positioned beneath said basket;
an eccentric shaft coupled with said motor, said motor rotating said shaft;
a master magnet mounted on said eccentric shaft, said master magnet moving in a circular path when said shaft is rotated by said motor;
a slave magnet mounted on said basket and in spaced relation to said master magnet, said slave magnet being magnetically coupled to said master magnet; and
wherein said basket moves along said circular path when said spherical bearings are received within said circular tracks and said motor rotates said master magnet, and, said basket moves along said linear path when said spherical bearings are received within said linear tracks and said motor rotates said master magnet.

21. A device according to claim 20, further comprising a tub having a plurality of sidewalls attached to a bottom, said bottom being positioned between said master and said slave magnets, said spherical bearings being mounted on said bottom within said tub.

22. A device according to claim 20, further comprising:
first and second stop surfaces positioned in spaced relation beneath said basket; and
a pin projecting from said basket toward said stop surfaces, said pin being positioned between said stop surfaces when said spherical bearings are received within said linear tracks, said pin being engageable with said stop surfaces upon motion of said basket along said linear path, said stop surfaces limiting said linear motion of said basket.

23. (canceled)

24. A device according to claim 17, wherein each of said circular tracks comprises a plate having a circular groove therein.

25. A device according to claim 24, wherein said groove has an arcuate cross section with a radius of curvature substantially equal to the radius of curvature of said spherical bearings.

26. A device according to claim 19, wherein each of said linear tracks comprises a plate having a linear groove therein.

27. A device according to claim 26, wherein said groove has an arcuate cross section with a radius of curvature substantially equal to the radius of curvature of said spherical bearings.

28. A water bath for agitating a miscible material in a container, said water bath comprising:
a tub having a bottom and sidewalls connected thereto for holding said water;
a first pair of spherical bearings mounted on said bottom within said tub, said bearings of said first pair being separated from one another by a first distance;
a second pair of spherical bearings mounted on said bottom within said tub in space relation to said first pair, said bearings of said second pair being separated from one another by a second distance greater than said first distance;
a basket supported on said bearings within said tub;
a first pair of circular tracks mounted on said basket, said circular tracks of said first pair being separated from one another by said first distance for receiving said first pair of spherical bearings;
a second pair of circular tracks mounted on said basket in spaced relation to said first pair of tracks, said circular tracks of said second pair being separated from one another by said second distance for receiving said second pair of spherical bearings;
a first pair of linear tracks mounted on said basket, said linear tracks of said first pair being separated from one another by said first distance for receiving said first pair of spherical bearings;
a second pair of linear tracks mounted on said basket in spaced relation to said first pair of linear tracks, said linear tracks of said second pair being separated from one another by said second distance for receiving said second pair of spherical bearings; and
wherein said circular tracks of said first pair are positioned between said linear tracks of said second pair, and said linear tracks of said first pair are positioned between said circular tracks of said second pair, said basket being movable along a circular path when said spherical bearings are received within said circular tracks, said basket being movable along a linear path when said spherical bearings are received within said linear tracks.

29. A device according to claim 28, further comprising:
an electric motor positioned beneath said tub;
an eccentric shaft coupled with said motor, said motor rotating said shaft;
a master magnet mounted on said eccentric shaft, said master magnet moving in a circular path when said shaft is rotated by said motor;
a slave magnet mounted on said basket, said slave magnet being magnetically coupled to said master magnet; and wherein said basket moves along said circular path when said spherical bearings are received within said circular tracks and said motor rotates said master magnet, and, said basket moves along said linear path when said spherical bearings are received within said linear tracks and said motor rotates said master magnet.
